(19) United States
(12) Patent Application Publication
(10) Pub. No.: US 2014/0137483 A1
(43) Pub. Date: May 22, 2014

(54) MorphMe Shed

(71) Applicants: Walter Tong, Mansfield, TX (US); Dana Huyen Dinh, Mansfield, TX (US)

(72) Inventors: Walter Tong, Mansfield, TX (US); Dana Huyen Dinh, Mansfield, TX (US)

(21) Appl. No.: 13/866,047

(22) Filed: Apr. 19, 2013

Related U.S. Application Data
(60) Provisional application No. 61/723,670, filed on Nov. 7, 2012.

(51) Int. Cl. E04B 1/343; E04H 1/12; E04C 2/30

(52) U.S. Cl. CPC E04B 1/34357; E04C 2/30; E04H 1/12
USPC 52/2.11; 52/79.5

(57) ABSTRACT

A structure may include a side panel, a bottom panel may be connected to the side panel, a top panel may be connected to the side panel, and an end panel may be connected to the top panel. The side panel may be foldable to change the dimensions of the structure.

### PRIORITY

The present invention claims priority under 35 USC section 119 based upon a provisional application with a serial number and a filing date of 61/723,670 and Nov. 7, 2012.

### FIELD OF THE INVENTION

The present invention relates to structures and more particularly to a utility structure.

### BACKGROUND

Storage concerns for additional items such as lawn mowers and other personal equipment have been widely recognized. Preconstructed storage units are available for users, but the storage units have significant disadvantages.

U.S. Pat. No. 8,020,347 discloses a modular enclosure, such as a shed, which may include sidewalls and a roof. The roof, for example, may include one or more roof panels. The roof may also include a truss that is sized and configured to support the roof panels. The shed may also include one or more support beams that may be connected to the truss and may be connected to one or more panels. The shed may include one or more brackets used to connect a pair of panels that are positioned at an angle to form a corner of the shed. The shed may also include a cover, which may include one or more receiving portions sized and configured to receive at least a portion of the brackets. A plurality of roof panels may be positioned within a shipping container to form storage areas or cavities sized and configured to receive all or at least a portion of one or more floor panels.

U.S. Pat. No. 6,802,158 discloses a storage shed that is strong, durable, low-maintenance, easy to assemble and use, and relatively inexpensive to manufacture and ship, and can be mass produced. In one embodiment, a storage shed comprises a preformed floor; a plurality of preformed, plastic corner posts having bottoms which are configured to be mounted onto the floor to be spaced from each other, and two preformed, plastic braces having bottoms which are configured to be mounted onto the floor to be spaced from one another. A preformed roof truss is configured to be connected to tops of the two braces. The roof truss has a spring preload to pull the tops of the two braces toward one another. A preformed roof is attached to tops of the plurality of corner posts. A preformed front door is supported between two of the plurality of corner posts.

U.S. Pat. No. 6,523,308 discloses a rotating-cover storage shed for storing drums of material which is potentially hazardous to the environment. The shed provides a means for containing any leaking material and also provides for protection from the weather and from unauthorized access to the stored contents. Access to the contents is easily made by rotatably opening one of a pair of rotating cover sections.

U.S. Pat. No. 5,970,663 discloses a storage shed for providing easy access to tools and related items. Such shed includes a vertical imperforate back wall positionable at an elevated location with respect to a recipient surface such as the wall of a house. In association with the back wall are a front wall and parallel vertical side edges. A top edge is positionable parallel with the top edge of the back wall. The front wall has at least one large rectangular opening therein. Side walls couple the front and back walls. At least one door is positionable over a respective opening in the front wall. A pair of vertical side braces are located in the space formed between the front and rear walls and secured to the lateral side walls. The braces have horizontal slots at spaced elevations for shelf-receiving purposes, the slots being positioned in facing relationship in the braces. A plurality of shelves with lateral edges are received in the slots of the braces. A plurality of horizontal U-shaped rail sections have free ends in contact with the back wall and are located between opposed braces. The rail sections have horizontally aligned apertures along their lengths.

U.S. Pat. No. 4,549,841 discloses a shed for storing containers in a three-dimensional system essentially including rails laid on the floor, a crane movably supported on the rails, an elevating member on the crane for vertical elevatory movement, a spreader frame mounted on the elevating member for movement in a horizontal direction, brackets on the spreader frame capable of moving vertically, twist lock pins each twistably attached to one of the brackets, three-dimensional shelves arranged on the floor along the rails, and guides located horizontally on each of the shelves. The spreader frame is thrust from the elevating member toward one of the shelves, and the brackets are moved downwardly on to a container on the shelf while supporting the spreader frame by guides mounted on the shelf, to bring the twist lock pins into engagement with the container. Then the brackets are moved upwardly to lift the container from the shelf and the spreader frame is returned to the elevating member to thereby remove the container from the shelf by the crane. A container can be placed on one of the shelves by the crane by reversing the process described above.

### SUMMARY

A structure may include a side panel, a bottom panel may be connected to the side panel, a top panel may be connected to the side panel, and an end panel may be connected to the top panel.

The side panel may be foldable to change the dimensions of the structure.

The base may be hollow and may be fillable with liquid.

The side panel may include a hinge.

The hinge may include a weakened area.

The side panel may include a female section.

The female section may define a channel.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an end view of the structure of the present invention;

FIG. 2 illustrates a first male section and a second male section of the present invention;

FIG. 3 illustrates the side panel and a side channel of the present invention;

FIG. 4 illustrates the side panel and illustrates the hinges of the present invention;

FIG. 5 illustrates a top view of the side panel, folding portions and non-folding portions of the present invention;

FIG. 6 illustrates the node sliding along the side channel of the present invention;

FIG. 7 illustrates an end view of the structure of the present invention;

FIG. 8 illustrates the side panel being moved between a first position and a second position of the present invention;

FIG. 9 illustrates a perspective view of the structure of the present invention;

FIG. 10 illustrates a top view of the structure being partially folded and includes the side panel and the end panel of the present invention;

FIG. 11 illustrates a side view of the top panel and illustrates the male section, and the female section;

FIG. 12 illustrates an end view of the structure of the present invention;

FIG. 13 illustrates another aspect of the present invention;

FIG. 14 illustrates that the female section may be expandable in order to accommodate larger nodes;

FIG. 15 illustrates the structure with a flat top panel and illustrates the side panel;

FIG. 16 illustrates the top panel which includes a hinge which extends along the peak of the top panel;

FIG. 17 illustrates the side panel positioned in the side channel;

FIG. 18 illustrates a first portion of the side panel being angled;

FIG. 19 illustrates a top view of the side panel which may include folding portions and may include non-folding portions;

FIG. 20 illustrates an end view of the bottom panel;

FIG. 21 illustrates a wheel and the wheel nodes;

FIG. 22 illustrates the structure with the female section positioned in the bottom surface of the end panel.

### DETAILED DESCRIPTION

The present invention provides a shed/storage/container which provides substantially unlimited uses but not limited to a container, storage, people, pet housing, greenhouse and other types of similar containers. The present invention employs plugging in or snapping in structures. The advantages of the present invention includes that the structure of the present invention may be assembled in a short amount of time compared to other traditional structures, requires minimal ground preparation and the base may be waterproof, may be available for a reasonable cost resulting from minimal assembly parts and current material technology advances such as lightweight plastic, resin, composite materials or other appropriate material. The present invention provide fixed or flexible sizes, mobility which may include using wheels such as an adjustable wheel for uneven ground, may provide decorative/advertising/marketing efforts using printed panels, may provide modularity capabilities, may provide a structure which is easy to transport and may provide unlimited usage.

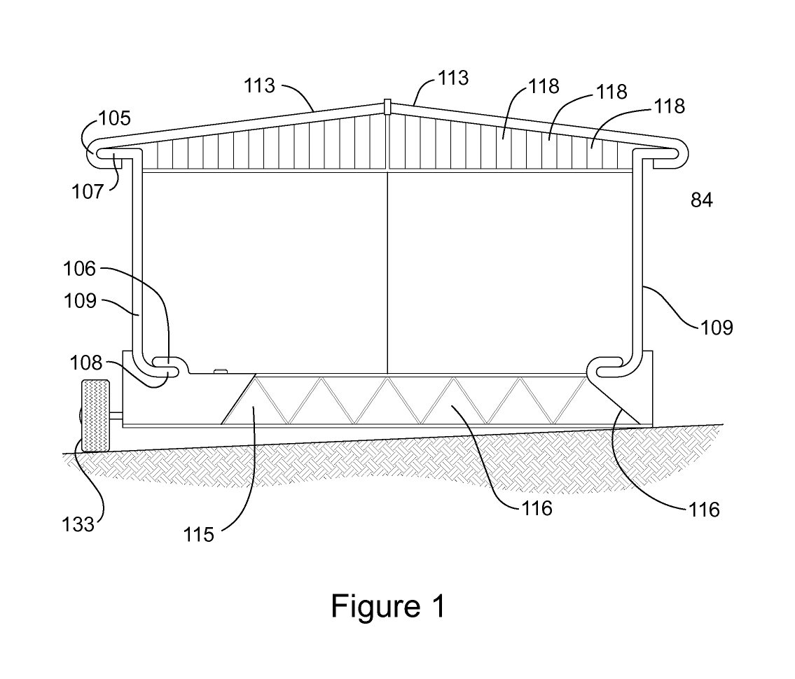

FIG. 1 illustrates an end view of the structure 101 of the present invention which may include a side panel 109 which may include a first male section 103 which may include a convex surface which may be in the shape of a node in order to cooperate with a first female section 105 which may include a concave surface and which may be integral with the top panel 113 and a second male section 104 may cooperate with a second female section 106 which may include a concave surface and which may be integral with the bottom panel 115. The first male section 103 may be positioned on the top of the side panel 109, and the second male section 104 may be positioned on the bottom of the side panel 109. The side panel 109 may be one of a pair of opposing side panels 109. The first male section 103 and the second male section 104 may be one of a pair of opposing first male sections 103 and the second male sections 104 which may be found on opposing ends of the side panel 109. The first female section 105 may define a first channel 107, and the second female section 106 may define a second channel 108. The first channel 107 may cooperate with the first male section 103, and the second channel 108 may cooperate with the second male section 104. The first channel 107 may be one of a pair of opposing first channels 107, and the second channel 108 may be one of a pair of opposing second channels 108.

The side panel 109 may be connected to a pair of opposing end panels 117 which may be positioned over a single or a pair of door panels 119 which may be hinged to open and close by a connection to the side panel 109. The end panel 117 may be foldable/accordion like by virtue of multiple hinges 118 which may be vertical and may be a weakened area of the material such as plastic or other appropriate material in order to extend and retract the end panel 117.

The side panel 109 may be connected to a bottom panel 115 which may be positioned under a single or a pair of door panels 119 which may be hinged to open and close by a connection to the side panel 109. The bottom panel 115 may be foldable/accordion like by virtue of multiple hinges 116 which may be a weakened area of the material such as plastic or other appropriate material in order to extend and retract the end panel 117.

FIG. 1 illustrates that the bottom panel 115 may include wheel nodes 131 positioned on opposing ends of the bottom panel 115 and which may be an array of wheels/rollers in order to transport the bottom panel 115 or to transport the entire structure 100 or a portion of the same. In addition, a wheel 133 may be mounted on an axle to facilitate the movement of the bottom panel 115 and/or the structure 100 of the present invention.

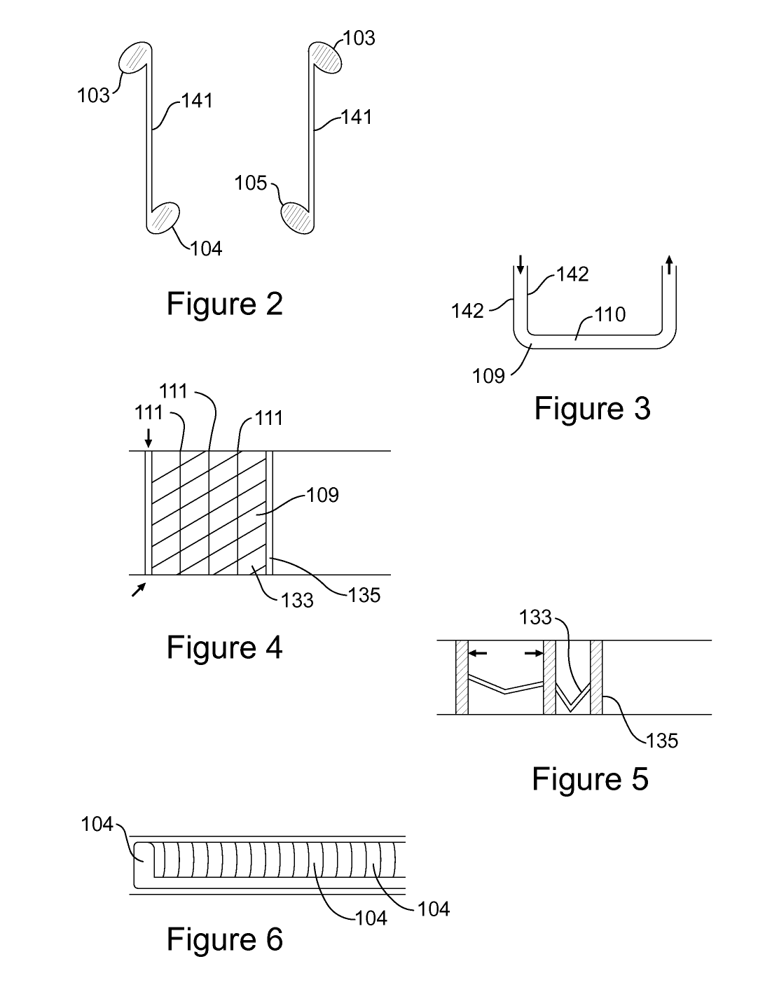

FIG. 2 illustrates a first male section 103 and a second male section 104 which may be connected by a connection rod 141.

FIG. 3 illustrates the side panel 109 which may include a side channel 110 which may be defined by upward extending walls 142 to accommodate the male section 104.

FIG. 4 illustrates the side panel 109 and illustrates the hinges 111 to fold the side panel as an accordion. The side panel 109 may include folding portions 133 and may include non-folding portions 135.

FIG. 5 illustrates a top view of the side panel 109 which may include folding portions 133 and may include non-folding portions 135.

FIG. 6 illustrates the node 104 sliding along the side channel 110.

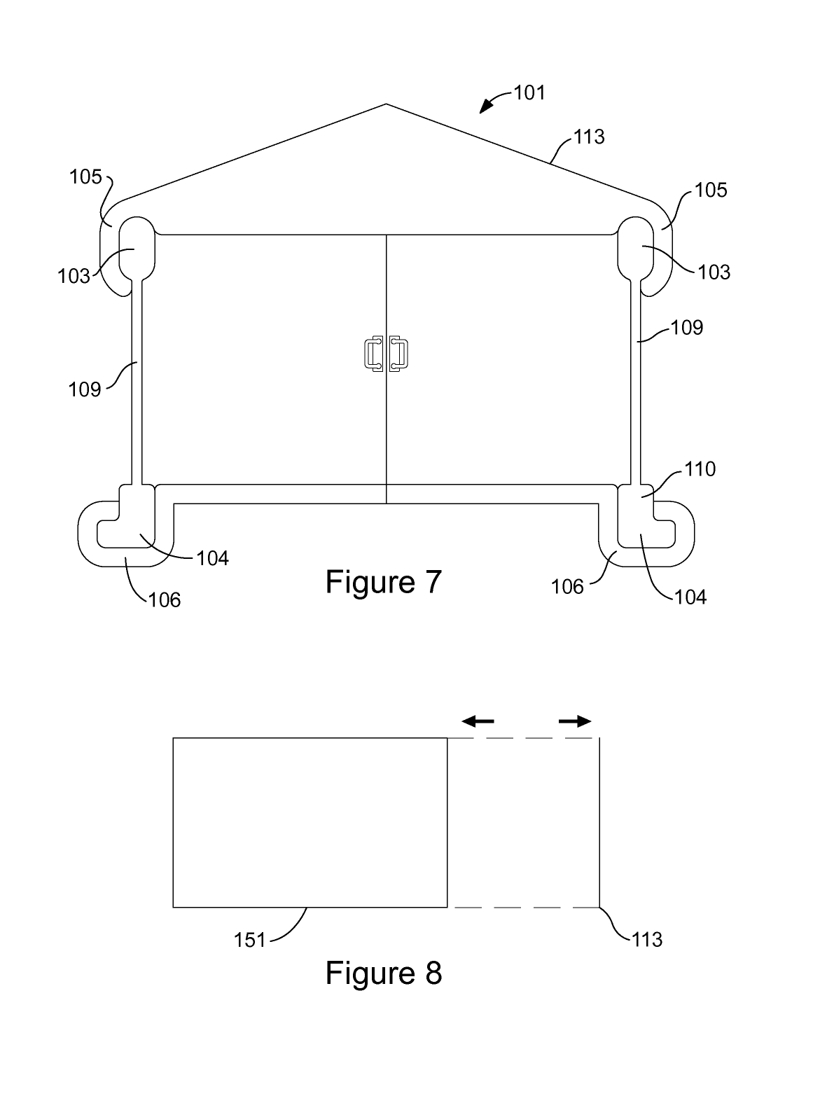

FIG. 7 illustrates an end view of the structure 101 of the present invention which may include a side panel 109 which may include a first male section 103 which may include a convex surface which may be in the shape of a node in order to cooperate with a first female section 105 which may include a concave surface and which may be integral with the top panel 113 and a second male section 104 may cooperate with a second female section 106 which may include a concave surface and which may be integral with the bottom panel 115. The first male section 103 may be positioned on the top of the side panel 109, and the second male section 104 may be positioned on the bottom of the side panel 109. The side panel 109 may be one of a pair of opposing side panels 109. The first male section 103 and the second male section 104 may be one of a pair of opposing first male sections 103 and the second male sections 104 which may be found on opposing ends of the side panel 109. The first female section 105 may define a first channel 107, and the second female section 106 may define a second channel 108. The first channel 107 may cooperate with the first male section 103, and the second channel 108 may cooperate with the second male section 104. The first channel 107 may be one of a pair of opposing first channels 107, and the second channel 108 may be one of a pair of opposing second channels 108.

FIG. 8 illustrates the side panel 109 being moved between a first position 151 and a second position 153.

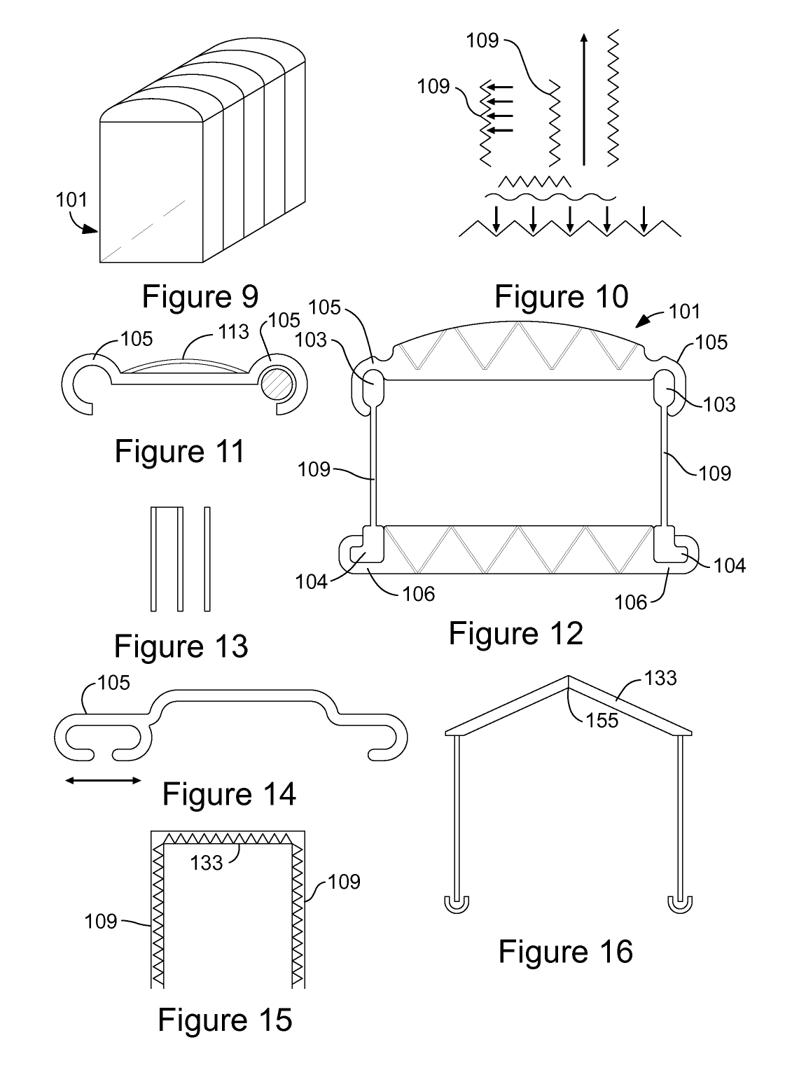

FIG. 9 illustrates a perspective view of the structure 101.

FIG. 10 illustrates a top view of the structure 101 being partially folded and includes the side panel 109 and the end panel 117.

FIG. 11 illustrates a side view of the top panel 113 and illustrates the male section 103, and the female section 105.

FIG. 12 illustrates an end view of the structure 101 of the present invention which may include a side panel 109 which may include a first male section 103 which may include a convex surface which may be in the shape of a node in order to cooperate with a first female section 105 which may include a concave surface and which may be integral with the top panel 113 and a second male section 104 may cooperate with a second female section 106 which may include a concave surface and which may be integral with the bottom panel 115. The first male section 103 may be positioned on the top of the side panel 109, and the second male section 104 may be positioned on the bottom of the side panel 109. The side panel 109 may be one of a pair of opposing side panels 109. The first male section 103 and the second male section 104 may be one of a pair of opposing first male sections 103 and the second male sections 104 which may be found on opposing ends of the side panel 109. The first female section 105 may define a first channel 107, and the second female section 106 may define a second channel 108. The first channel 107 may cooperate with the first male section 103, and the second channel 108 may cooperate with the second male section 104. The first channel 107 may be one of a pair of opposing first channels 107, and the second channel 108 may be one of a pair of opposing second channels 108.

FIG. 13 illustrates a ???.

FIG. 14 illustrates that the female section 105 may be expandable in order to accommodate larger nodes 104.

FIG. 15 illustrates the structure 101 with a flat top panel 113 and illustrates the side panel 109.

FIG. 16 illustrates the top panel 113 includes a hinge 115 which extends along the peak of the top panel 113 to fold the top panel 113.

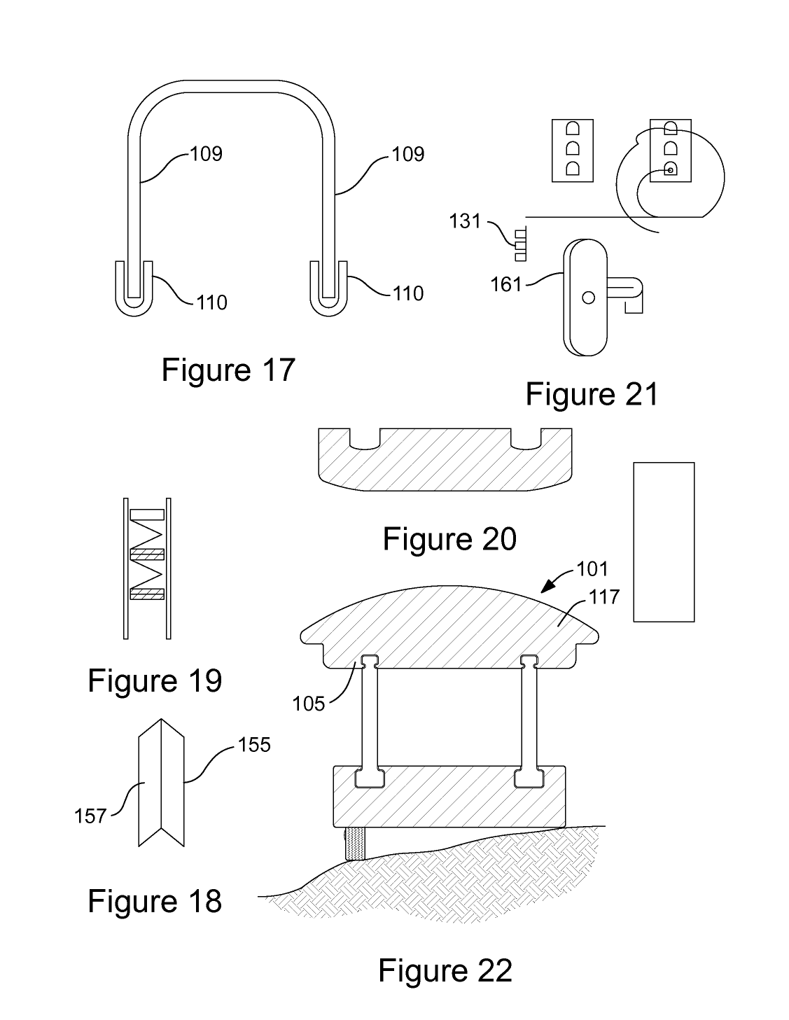

FIG. 17 illustrates the side panel 109 positioned in the side channel 110.

FIG. 18 illustrates a first portion 157 of the side panel 109 being angled with respect to the second portion 159 of the side panel 109.

FIG. 19 illustrates a top view of the side panel 109 which may include folding portions 133 and may include non-folding portions 135.

FIG. 20 illustrates an end view of the bottom panel 115.

FIG. 21 illustrates a wheel 161 and the wheel nodes 131.

FIG. 22 illustrates the structure 101 with the female section 105 positioned in the bottom surface of the end panel 117 and the female section 106 positioned in the top surface of the bottom panel 105.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A structure, comprising:
a side panel;
a bottom panel connected to the side panel;
a top panel connected to the side panel;
an end panel connected to the top panel;
wherein the side panel is foldable to change the dimensions of the structure.

2) A structure as in claim 1, wherein the base is hollow and may be fillable with liquid.

3) A structure as in claim 1, wherein the side panel includes a hinge.

4) A structure as in claim 3, wherein the hinge includes a weakened area.

5) A structure as in claim 1, wherein the side panel includes a female section.

6) A structure as in claim 5, wherein the female section defines a channel.

7) A structure as in claim 6, wherein the side panel includes a male section to cooperate with the channel.
